(19) United States
(12) Patent Application Publication
(10) Pub. No.: US 2026/0166764 A1
(43) Pub. Date: Jun. 18, 2026

(54) KNIFE BLADE WITH LASER-WELDED JOINT

(71) Applicant: KAI Corporation, Tokyo (JP)

(72) Inventor: Craig Green, Tualatin, OR (US)

(21) Appl. No.: 19/417,064

(22) Filed: Dec. 11, 2025

Related U.S. Application Data
(60) Provisional application No. 63/733,284, filed on Dec. 12, 2024.

(51) Int. Cl. B26B 9/00; B23K 26/24; B26B 1/02

(52) U.S. Cl. CPC B26B 9/00; B23K 26/24; B26B 1/02

(57) ABSTRACT

A method of manufacture of a knife blade comprises: (a) abutting a cutting body conformably to a spine body at a joint edge of the cutting body, the cutting body comprising a cutting material, and the spine body comprising a spine material distinct from the cutting material; and (b) directing laser radiation onto the joint edge from opposite sides of the cutting and spine bodies concurrently, thereby forming a laser-welded joint joining the cutting and spine bodies along the joint edge. In an example, the laser-welded joint comprises no material other than the cutting material and the spine material.

### CROSS REFERENCE TO RELATED APPLICATIONS

This application claims priority to 63/733,284, filed Dec. 12, 2024, the entirety of which is hereby incorporated herein by reference for all purposes.

### TECHNICAL FIELD

This disclosure relates generally to knife-blade manufacture and, more particularly, to laser welding as applied to knife-blade manufacture.

### BACKGROUND

Cutting tools such as knives can include a blade and a handle. Kitchen knives, hunting knives, and swords are examples of knives that can have a handle. The blade of a knife can take the form of a fixed blade or a folding blade. Some knives may not be intended to be held in the hand, such as bayonets and knives integral to woodworking tools, including hand planers, thickness planers, and jointers, as examples. Knives can feature a serrated blade in some examples, and may take the form of a saw in an example.

### SUMMARY

In a disclosed example, a method of manufacture of a knife blade comprises: (a) abutting a cutting body conformably to a spine body at a joint edge of the cutting body, the cutting body comprising a cutting material, and the spine body comprising a spine material distinct from the cutting material; and (b) directing laser radiation onto the joint edge from opposite sides of the cutting and spine bodies concurrently, thereby forming a laser-welded joint joining the cutting and spine bodies along the joint edge. In an example, the laser-welded joint comprises no material other than the cutting material and the spine material.

In a disclosed example, a knife blade, comprises: a cutting body comprising a cutting material, the cutting body having a cutting edge and a joint edge opposite the cutting edge; and a spine body comprising a spine material distinct from the cutting material, the spine body conforming fittably to the joint edge of the cutting body; and a laser-welded joint joining the cutting body to the spine body along the joint edge, the laser-welded joint formed via laser radiation directed onto the joint edge from both sides of the cutting and spine bodies concurrently.

### BRIEF DESCRIPTION OF THE DRAWINGS

FIG. 1 shows aspects of an example knife.

FIG. 2 shows aspects of an example method of manufacture of a knife blade.

FIG. 3 shows aspects of example cutting and spine bodies of a knife blade.

FIG. 4 shows aspects of cutting and spine bodies of a knife blade fixed to a jig, in one, non-limiting example.

FIG. 5 shows aspects of laser welding a cutting body of a knife blade to a spine body of a knife blade in one, non-limiting example.

FIG. 6 shows aspects of an example robotic laser-welding system.

FIGS. 7 and 8 show aspects of an example laser-welding system based on a programmable milling machine.

### DETAILED DESCRIPTION

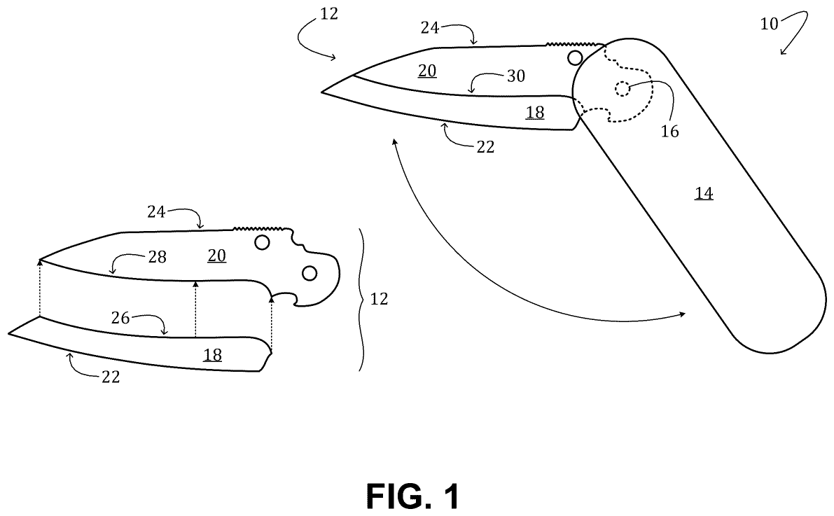

FIG. 1 shows aspects of an example knife 10. A ‘knife’ is defined herein as a cutting tool having a single, sharp blade. The illustrated knife 10 is a folding knife. Blade 12 is shown extended intermediately outward from handle portion 14 in the drawing; it can also be extended fully (180 degrees from the handle portion) or folded back into the handle portion. Rotational bearing 16 supports the folding operation. More generally, this disclosure is consonant with many kinds of knives, folding and otherwise. Examples include kitchen knives, hunting knives, and swords, all of which have a handle portion. This disclosure is also consonant with knives that are not intended to be held in the hand. Examples include bayonets and knives integral to woodworking tools—hand planers, thickness planers, and jointers, for example. Knives can feature a serrated blade in some examples, and can take the form of a saw in an example. The term ‘blade’ refers herein to the part of a knife intended to contact the material being cut. Not all of the blade need contact such material in every example and scenario. For instance, this disclosure is consonant with a kitchen knife in which the blade extends all the way through the handle portion, for durability.

Continuing in FIG. 1, knife blade 12 includes cutting body 18 and spine body 20. The cutting body comprises a cutting material and includes a sharp cutting edge 22. The spine body comprises a spine material distinct from the cutting material. In most knife blades the spine edge 24 of the spine body is not sharp.

Forming a knife blade from materially distinct cutting and spine bodies provides certain advantages. For instance, the cutting material can be optimized for cutting: it can be a hard material which is easily sharpened and holds its edge very well. These properties, useful for cutting body 18, may be less useful for spine body 20. Accordingly, it may be desirable to make the spine body from a softer or less easily sharpened spine material, especially if a suitable spine material which is less expensive than the cutting material is available. In these and other examples, the selected cutting material may be more corrosion-resistant than the spine material.

In some examples the spine material may be selected to optimize properties of spine body 20 that are less relevant with respect to cutting body 18. For example the spine material may be selected to optimize strength, flexibility, and/or elasticity—i.e., the ability to spring back to its engineered configuration after experiencing strain. In some examples the spine material may be selected to optimize the strength of a weld to a pre-selected cutting material. In some examples the spine material may be selected to optimize ease of polishing or the ability to hold a high polish, or ease of electroplating, electroless plating, or other types of finishing. In some examples the spine material may be selected based partly on the appearance of the spine body in juxtaposition to the cutting body—being visually distinct in some examples or visually indistinct in others. In some examples the spine material may be selected based partly on economy.

In some examples the cutting material comprises a first steel composition, and the spine material comprises a second steel composition. In some, non-limiting examples, the cutting material may comprise a high-alloy powdered stainless steel, tool steel, or high-speed steel. In these and other examples the spine material may comprise any Martensitic stainless steel—e.g., 410 SS, 420 SS, 420HC SS, stainless Damacus, or carbon-steel Damascus, among others.

In the example illustrated in FIG. 1, spine body 20 is larger than cutting body 18. Generally speaking, the size of the spine body relative to the cutting body is not particularly limited. In some examples, however, at least some of the advantages of forming a knife blade from cutting and spine bodies comprising different materials may be greater in configurations in which the spine body is larger than the cutting body. In other examples, such advantages may be greater when the cutting body is larger than the spine body, or when the cutting and spine bodies are of comparable size.

Cutting body 18 has a joint edge 26 opposite cutting edge 22. In the illustrated example the joint edge is a smooth, curved line. In other examples the joint edge may be a straight line or a jagged line. Spine body 20 conforms fittably to the joint edge of the cutting body. In other words, the edge of the spine body that meets the joint edge of the cutting body (edge 28 in FIG. 1) is a geometric complement of the joint edge. Shown also in FIG. 1, a laser-welded joint 30 joins the cutting body to the spine body along the joint edge. As described hereinafter, the laser-welded joint is formed via laser radiation directed onto the joint edge from both sides of the cutting and spine bodies concurrently.

Laser-welded joint 30 is a weld between the cutting material and the spine material wherein the cutting material and the spine material are inter-diffused. The laser-welded joint is thereby configured to resist separation under stresses exerted on the knife blade during expected use. The inter-diffusion of the cutting material and the spine material extends at least partway through the thickness of knife blade 12. In some examples the inter-diffusion of the cutting material and the spine material extends all the way through the thickness of the knife blade (i.e., full penetration). Generally speaking, laser-welded joint 30 is continuous because it follows joint edge 26, which is continuous. In some examples spine body 20 comprises no other welded joint besides laser-welded joint 30. Provided that the cutting and spine materials are selected for weld compatibility, a laser-welded joint is stronger than a brazed or soldered joint. In some examples, accordingly, the laser-welded joint may comprise no material other than the cutting material and the spine material.

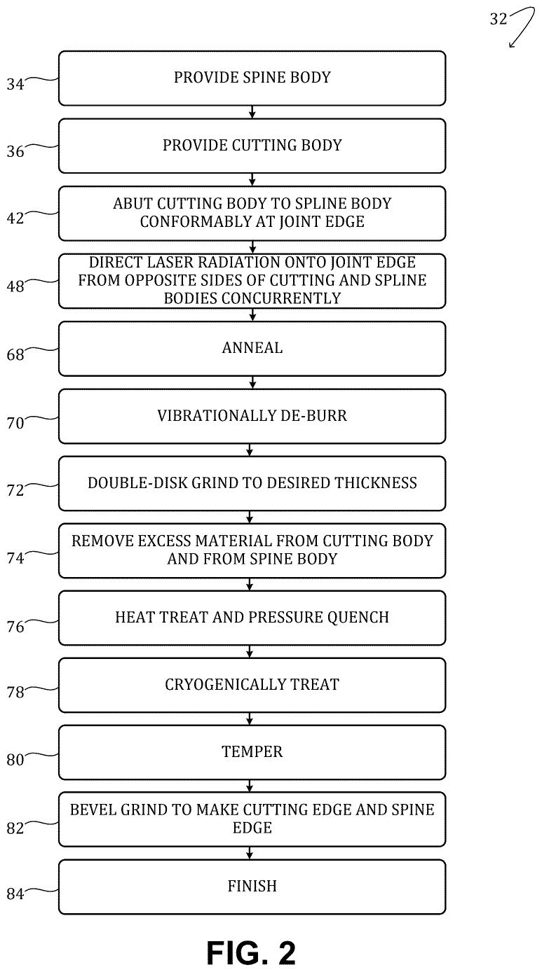

FIG. 2 shows aspects of an example method 32 of manufacture of a knife blade. Although some aspects of the method are described with continued reference to the part names and numbers introduced above, it will be noted that the method is applicable to the manufacture of knife blades that differ even significantly from knife blade 12.

At 34 of method 32 the spine body of the knife blade is provided. As described above, the spine body comprises a spine material. The process of manufacture of the spine body is not particularly limited. In some examples the initial form of the spine body may comprise a fine blank. In some examples the blank may be formed by stamping. In some examples the blank may be formed by machining. In some examples the blank may be formed by stamping followed by machining.

At 36 the cutting body of the knife blade is provided. As described above, the cutting body comprises a cutting material distinct from the spine material. As in the case of the spine body, the cutting body may be formed by stamping and/or machining in some examples. In these and other examples, laser cutting and/or water-jet cutting may be used to define (or refine) the form of the cutting body at this point in method 32.

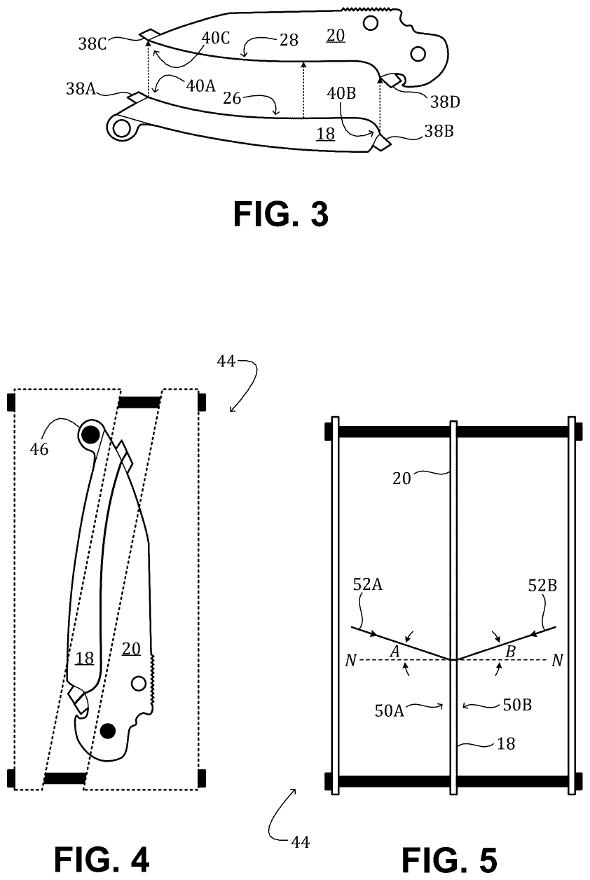

FIG. 3 shows aspects of an example cutting body 18 and spine body 20 as provided in the foregoing method steps. Cutting body 18 includes excess material 38A at first end 40A of joint edge 26 and excess material 38B at second end 40B of joint edge 26. Likewise, spine body 20 includes excess material 38C and 38D at both ends of edge 28, intended to conform fittably to the joint edge of the cutting body. Thus, when the cutting body is abutted conformably to the spine body (vide infra), the excess material on the spine body will be located at the first and second ends of the joint edge. More generally, in examples where the cutting body includes excess material, such material may be arranged at one or both ends of the joint edge; and in examples where the spine body includes excess material, such material may be arranged at one or both ends of the joint edge after conformal abutment of the cutting and spine bodies. As described hereinafter, the purpose of the excess material is to reduce thermal endpoint effects during subsequent laser welding.

Returning now to FIG. 2, at 42 the cutting body is abutted conformably to the spine body at the joint edge of the cutting body. In some examples conformably abutting the cutting body to the spine body comprises fixing the cutting and spine bodies to a stationary or translating jig, which lightly forces or otherwise biases the spine body against the joint edge of the cutting body. FIG. 4 shows aspects of cutting body 18 and spine body 20 fixed to an example jig 44. In the illustrated configuration, eyelet 46 is arranged on cutting body 18 in order to facilitate attachment of the cutting body to the jig. Other such features may also be included on the cutting and/or spine bodies.

Returning again to FIG. 2, at 48 of method 32, laser radiation is directed onto the joint edge from opposite sides of the cutting and spine bodies concurrently, thereby forming a laser-welded joint joining the cutting and spine bodies along the joint edge. FIG. 5 shows aspects of this feature. As shown in this drawing, cutting body 18 and spine body 20 comprise, when conformably abutted, a first face 50A and a second face 50B opposite the first face. Directing the laser radiation from opposite sides comprises directing a first beam 52A of the laser radiation onto the first face and directing a second beam 52B of the laser radiation onto the second face. The first beam is directed at a first angle A measured against the surface normal N; the second beam is directed at a second angle B measured against N. In some examples the first angle A and/or the second angle B is an oblique angle. In other examples both A and B may be right angles. The first and second angles may be equal in some examples and scenarios, and unequal in others. In some examples the laser-welding may be enacted under a blanket of an inert gas, such as argon, to avoid oxidation of the cutting and spine materials. In some examples inert-gas outlets may be incorporated into the laser torches on opposite sides of the cutting and spine bodies, which emit the first and second beams.

The reason for directing the laser radiation concurrently onto the first and second faces is to balance the mechanical stresses exerted at the joint edge after inter-diffusion of the cutting and spine materials and subsequent cooling. If only one side is irradiated, the resulting stresses may induce a small but undesired curvature to the knife blade or may weaken the joint.

At 48 of method 32, the laser radiation is directed such that the focus of the laser radiation travels along the joint edge, from one end of the joint edge to the other end of the joint edge. This can be achieved by holding the cutting and spine bodies fixed and varying the origin and orientation of the laser beams, by holding the laser beams fixed and translating the cutting and spine bodies, or by any suitable combination of these actions. Accordingly, the term ‘travels along the joint edge’ is broadened herein to include relative travel of the focus with respect to the cutting and spine bodies along the joint edge.

Irrespective of the detailed approach, the radiation induces a thermal gradient that travels with the focus, wherein the temperature is greatest at the focus and falls off with increasing lateral distance along the cutting and spine bodies. If the relative velocity of the focus is constant (or nearly so), then the thermal gradient may be substantially constant also, provided that focus is suitably far from either end of the joint edge. Closer to the ends of the joint edge, however, the heat induced by the laser radiation may not dissipate as rapidly, which may result in unbalanced thermal stresses at both ends of the laser weld. This is the reason for including excess material at one or both ends of the joint edge. In examples in which the excess material is included and the weld extends all the way through the excess material, any unbalanced thermal stresses that may occur are confined to the excess material. As noted hereinafter, the stressed, excess material is trimmed away later in method 32 and is therefore not a part of the resulting knife blade.

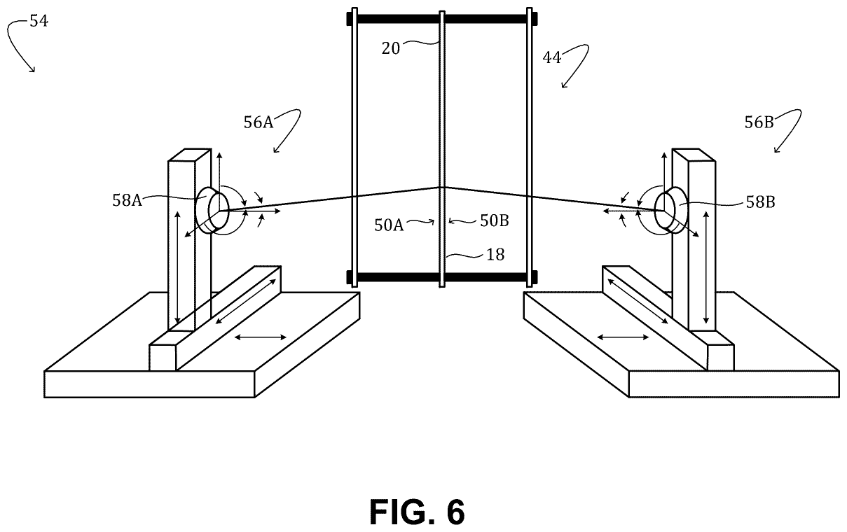

FIG. 6 shows aspects of an example robotic laser-welding system 54 that can be used at 48 of method 32. The robotic laser-welding system includes first robotic arm 56A, second robotic arm 56B, and a stationary jig 44 configured to hold cutting body 18 and spine body 20. Coupled to the free end of each robotic arm is a laser torch, 58A and 58B. Each of the first and second robotic arms is configured to control the position of the associated laser torch along three degrees of translational freedom and to control the orientation of the beam emitted by the laser torch about three degrees of rotational freedom. In this manner, laser-welding system 54 is configured to vary the origin and direction of the laser beams emanating from laser torches 58A and 58B, providing overall six degrees-of-freedom (6DOF) control of each beam. In some examples and scenarios the laser beams may be coaxial; in other examples and scenarios the laser beams may be staggered or differentially positioned in any suitable arrangement. More generally, in this example and others, directing the laser radiation at 48 of method 32 may comprise varying the origin and/or direction of the two or more laser beams.

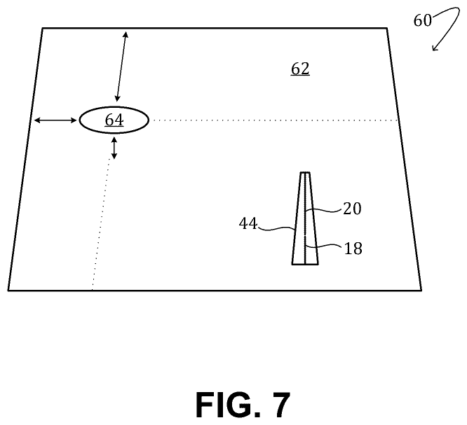

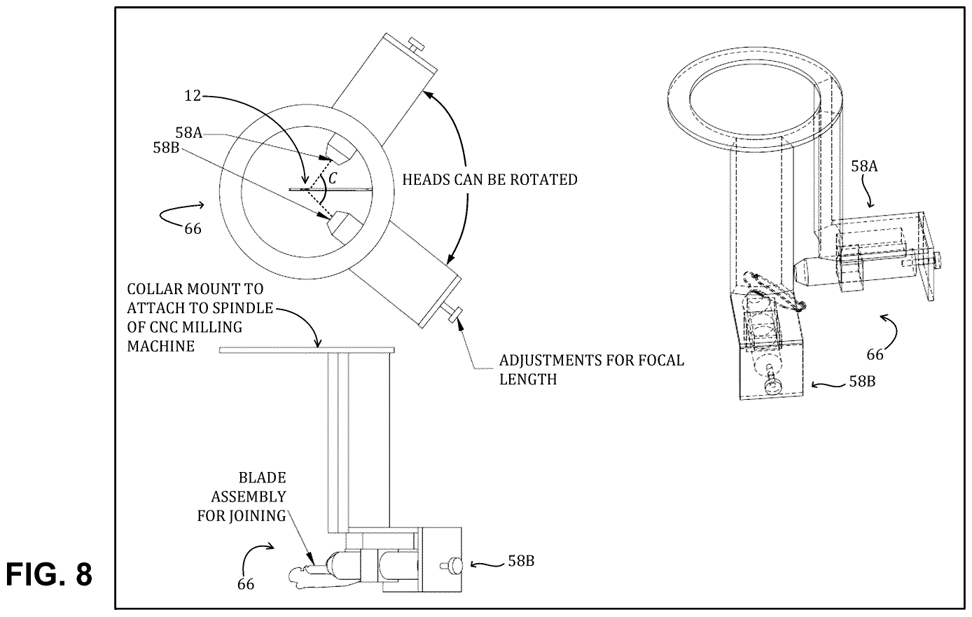

FIG. 7 shows aspects of another example laser-welding system that can be used at 48 of method 32. Laser-welding system takes the form of a programmable milling machine 60 comprising a platen 62 and a traveling chuck 64. In some examples the programmable milling machine may take the form of a CNC machine. Stationary jig 44 is coupled to the platen. The stationary jig is configured to hold cutting body 18 and spine body 20. Installed in the traveling chuck is an attachment 66, which is shown in greater detail in several views of FIG. 8. The attachment comprises a first laser torch 58A and a second laser torch 58B. The second laser torch is mounted to a rotational actuator that controls the angle C between the beams emitted by the first and second laser torches. Each laser torch provides a focal-length adjustment for the corresponding beam. In this example and in the example above, the jig is stationary. In other examples the jig may move in the direction parallel to knife blade 12. In some examples and scenarios the laser beams may be coaxial; in other examples and scenarios the laser beams may be staggered or differentially positioned in any suitable arrangement. Thus, directing the laser radiation at 48 of method 32 may comprise controlling programmable milling machine 60, attachment 66, laser torches 58A and 58B, and jig 44 (if the jig is not stationary).

A broad range of laser torches is envisaged in connection to the laser-welding aspect of this disclosure. In some examples each laser torch includes an infrared-emitting laser, although visible-emitting laser may also be used. Typical laser configurations include optically pumped ruby or neodymium yttrium-aluminum-garnet (Nd:YAG) lasers, or electrically pumped gas lasers. In some examples the beam is focused down to a spot size of about 2 square millimeters (mm²). In some examples the power output of each of the laser torches may be within the range of 500 to 4000 watts, depending on the material type, thickness, and desired process speed. At the lower limit of this range the beams would have to travel the joint edge very slowly to achieve the desired penetration depth. At the upper end of the range, the rate of travel may be so rapid as to reduce the precision of control of the spot position along the joint edge. A lasers torch may be operated continuous-wave mode or in any desired pulsed mode—e.g., to control the fusion depth, heating rate, and/or cooling rate. In some examples the laser torches may be pulsed in a pre-determined pattern to achieve the desired penetration into the blade. For instance, one or more of a pulse separation and pulse width of the laser radiation may be varied so as to control a temperature and/or fusion depth of the laser-welded joint. In some examples, accordingly, the laser radiation at 48 of method 32 comprises controllably pulsed radiation.

Returning once again to FIG. 2, at 68 the knife blade is annealed. In examples in which the cutting and spine materials are different kinds of steel, suitable annealing conditions comprise heating in vacuo to within a range of 1300 to 1600° F., soaking within that range for two hours, reducing the temperature to about 1000° F. at about 50° F. per hour, and then cooling to room temperature at about 50° F. per hour. At 70 the knife blade is vibrationally de-burred.

At 72 the knife blade is double-disk ground to a desired thickness. For examples in which the knife blade is the blade of a folding knife, the thickness may be from about 0.150 to 0.020 inch in the joint area and may vary linearly to about 0.005 to 0.025 inch at the cutting edge.

At 74 the excess material is removed from the cutting body and from the spine body. The excess material may be removed by machining or grinding. At 76 the knife blade is heat-treated in vacuo and pressure quenched under nitrogen. In examples in which the cutting and spine materials are different kinds of steel, suitable heat-treatment conditions comprise heating to about 1600° F., equalizing the temperature, further heating to within a range of 1950 to 2200° F., and holding the temperature within that range for 10 to 30 minutes. Quenching under nitrogen may be enacted at 2 bar or greater pressure, to a temperature of about 125° F. At 78 the knife blade is cryogenically treated. In examples in which the cutting and spine materials are different kinds of steel, suitable cryogenic treatment conditions comprise prompt (after the above heat treatment) further treatment at −160° F. At 80 the knife blade is tempered. In examples in which the cutting and spine materials are different kinds of steel, suitable tempering conditions comprise double tempering at 300 to 450° F., holding for about two hours each time.

At 82 the knife blade is bevel-ground in order to make a sharp cutting edge and a blunt spine edge. At 84 the knife blade is finished to provide one or more of a high polish, a satin finish, a stonewash finish. In some examples a coating may be applied. In some examples the knife blade may be subjected to an acid etch. In some examples the knife blade by be laser marked—e.g., to accentuate the appearance of the laser-welded joint. At this point the knife blade is ready for assembly into a knife.

Pursuant to method 32, the knife blade may be ready for assembly into a knife. Such assembly may include attachment of a handle, application of a final coating, etc.

No aspect of the foregoing drawings or description should be interpreted in a limiting sense, because numerous variations, extensions, and omissions are also envisaged. For instance, the laser-welding described above is achieved without the aid of any filler material per se. In other examples, narrow rods or wires of the cutting and/or spine materials may be fed into the irradiated regions on both sides of the knife blade during the laser-weld process. The wires and/or rods may be guided robotically, for instance.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

It will be understood that the configurations and/or approaches described herein are exemplary and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. In that spirit, the phrase ‘based at least partly on’ is intended to remind the reader that the functional and/or conditional logic illustrated herein neither requires nor excludes suitable additional logic, executing in combination with the illustrated logic, to provide additional benefits. In that spirit, the phrase ‘based at least partly on’ is intended to remind the reader that the functional and/or conditional logic illustrated herein neither requires nor excludes suitable additional logic, executing in combination with the illustrated logic, to provide additional benefits. In some examples the terms ‘about’ and ‘approximately’, as applied to a numeric value x, expand x to include any value in a range between 0.9x and 1.1x; in some examples these terms expand x to include any value in a range between 0.95x and 1.05x.

Further, the disclosure comprises configurations according to the following examples.
Example 1. A knife blade, comprising: a cutting body comprising a cutting material, the cutting body having a cutting edge and a joint edge opposite the cutting edge; and a spine body comprising a spine material distinct from the cutting material, the spine body conforming fittably to the joint edge of the cutting body; and a laser-welded joint joining the cutting body to the spine body along the joint edge, the laser-welded joint formed via laser radiation directed onto the joint edge from both sides of the cutting and spine bodies concurrently.
Example 2. The knife blade of Example 1, wherein the cutting material is harder than the spine material.
Example 3. A method of manufacture of a knife blade, the method comprising: abutting a cutting body conformably to a spine body at a joint edge of the cutting body, the cutting body comprising a cutting material, and the spine body comprising a spine material distinct from the cutting material; and directing laser radiation onto the joint edge from opposite sides of the cutting and spine bodies concurrently, thereby forming a laser-welded joint joining the cutting and spine bodies along the joint edge, the laser-welded joint comprising no material other than the cutting material and the spine material.
Example 4. The method of Example 3, wherein the cutting material comprises a first steel composition and the spine material comprises a second steel composition.
Example 5. The method of Example 3, wherein the cutting and spine bodies conformably abutted comprise a first face and second face opposite the first face, and wherein directing the laser radiation comprises directing a first beam of the laser radiation onto the first face at a first angle and directing a second beam of the laser radiation onto the second face at a second angle, and wherein the first and/or second angle is oblique.
Example 6. The method of Example 3, wherein the joint edge comprises a curved line.
Example 7. The method of Example 3, wherein the joint edge is continuous, and wherein spine body comprises no other welded joint.
Example 8. The method of Example 3, wherein the cutting body includes excess material at one or both ends of the joint edge, and the spine body includes excess material at one or both ends of the joint edge, the method further comprising: removing the excess material from the cutting body; and removing the excess material from the spine body.
Example 9. The method of Example 3, wherein the laser radiation comprises controllably pulsed laser radiation.
Example 10. The method of Example 9, further comprising varying one or more of a pulse separation and pulse width of the laser radiation so as to control a temperature and/or fusion depth of the laser-welded joint.
Example 11. The method of Example 3, wherein conformably abutting the cutting body to the spine body comprises fixing the cutting and spine bodies to a stationary or translating jig.
Example 12. The method of Example 3, wherein directing the laser radiation comprises varying an origin and/or direction of two or more laser beams.
Example 13. The method of Example 3, wherein directing the laser radiation comprises controlling a programmable milling machine with a traveling chuck, and wherein an attachment comprising two or more laser torches is installed in the chuck.
Example 14. The method of Example 3, further comprising forming the cutting body via laser or water-jet cutting.
Example 15. The method of Example 3, further comprising annealing the knife blade.
Example 16. The method of Example 3, further comprising vibrationally de-burring and double-disk grind the knife blade to a desired thickness.
Example 17. The method of Example 3, further comprising heat treating the knife blade in vacuo and pressure quenching under nitrogen.
Example 18. The method of Example 3, further comprising cryogenically treating and tempering the knife blade.
Example 19. The method of Example 3, further comprising bevel grinding the knife blade to make the cutting edge and a spine edge.
Example 20. The method of Example 3, further comprising finishing the knife blade to provide one or more of a high polish, a satin finish, a stonewash finish, a coating, an acid etch, and/or a laser mark.

It will be understood that the configurations and/or approaches described herein are exemplary in nature, and that these specific embodiments or examples are not to be considered in a limiting sense, because numerous variations are possible. The specific methods described herein may represent one or more of any number of processing strategies. As such, various acts illustrated and/or described may, in at least some examples, be performed in the sequence illustrated and/or described, in other sequences, in parallel, or omitted. Likewise, the order of the above-described processes and operations may be changed in at least some examples.

The subject matter of the present disclosure includes all novel and non-obvious combinations and sub-combinations of the various methods and configurations, and other features, functions, acts, and/or properties disclosed herein, as well as any and all equivalents thereof.

1. A knife blade, comprising:
a cutting body comprising a cutting material, the cutting body having a cutting edge and a joint edge opposite the cutting edge; and
a spine body comprising a spine material distinct from the cutting material, the spine body conforming fittably to the joint edge of the cutting body; and
a laser-welded joint joining the cutting body to the spine body along the joint edge, the laser-welded joint formed via laser radiation directed onto the joint edge from both sides of the cutting and spine bodies concurrently.

2. The knife blade of claim 1, wherein the cutting material is harder than the spine material.

3. A method of manufacture of a knife blade, the method comprising:
abutting a cutting body conformably to a spine body at a joint edge of the cutting body, the cutting body comprising a cutting material, and the spine body comprising a spine material distinct from the cutting material; and
directing laser radiation onto the joint edge from opposite sides of the cutting and spine bodies concurrently, thereby forming a laser-welded joint joining the cutting and spine bodies along the joint edge, the laser-welded joint comprising no material other than the cutting material and the spine material.

4. The method of claim 3, wherein the cutting material comprises a first steel composition and the spine material comprises a second steel composition.

5. The method of claim 3, wherein the cutting and spine bodies conformably abutted comprise a first face and second face opposite the first face, and wherein directing the laser radiation comprises directing a first beam of the laser radiation onto the first face at a first angle and directing a second beam of the laser radiation onto the second face at a second angle, and wherein the first and/or second angle is oblique.

6. The method of claim 3, wherein the joint edge comprises a curved line.

7. The method of claim 3, wherein the joint edge is continuous, and wherein spine body comprises no other welded joint.

8. The method of claim 3, wherein the cutting body includes excess material at one or both ends of the joint edge, and the spine body includes excess material at one or both ends of the joint edge, the method further comprising:
removing the excess material from the cutting body; and
removing the excess material from the spine body.

9. The method of claim 3, wherein the laser radiation comprises controllably pulsed laser radiation.

10. The method of claim 9, further comprising varying one or more of a pulse separation and pulse width of the laser radiation so as to control a temperature and/or fusion depth of the laser-welded joint.

11. The method of claim 3, wherein conformably abutting the cutting body to the spine body comprises fixing the cutting and spine bodies to a stationary or translating jig.

12. The method of claim 3, wherein directing the laser radiation comprises varying an origin and/or direction of two or more laser beams.

13. The method of claim 3, wherein directing the laser radiation comprises controlling a programmable milling machine with a traveling chuck, and wherein an attachment comprising two or more laser torches is installed in the chuck.

14. The method of claim 3, further comprising forming the cutting body via laser or water-jet cutting.

15. The method of claim 3, further comprising annealing the knife blade.

16. The method of claim 3, further comprising vibrationally de-burring and double-disk grind the knife blade to a desired thickness.

17. The method of claim 3, further comprising heat treating the knife blade in vacuo and pressure quenching under nitrogen.

18. The method of claim 3, further comprising cryogenically treating and tempering the knife blade.

19. The method of claim 3, further comprising bevel grinding the knife blade to make the cutting edge and a spine edge.

20. The method of claim 3, further comprising finishing the knife blade to provide one or more of a high polish, a satin finish, a stonewash finish, a coating, an acid etch, and/or a laser mark.
